(19) United States
(12) Patent Application Publication
(10) Pub. No.: US 2023/0213332 A1
(43) Pub. Date: Jul. 6, 2023

(54) APPARATUS FOR CHARACTERIZATION OF GRAPHENE OXIDE COATINGS

(71) Applicant: Via Separations, Inc., Watertown, MA (US)

(72) Inventor: Brandon Ian MACDONALD, Maynard, MA (US)

(21) Appl. No.: 18/117,722

(22) Filed: Mar. 6, 2023

Related U.S. Application Data
(63) Continuation of application No. PCT/US2022/081163, filed on Dec. 8, 2022.
(60) Provisional application No. 63/287,726, filed on Dec. 9, 2021.

(51) Int. Cl. G01B 11/06; C01B 32/198

(52) U.S. Cl. CPC G01B 11/0625; C01B 32/198; G01B 11/0691; C01P 2002/84; C01P 2004/03

(57) ABSTRACT

An apparatus for measuring the thickness of graphene oxide coatings deposited on a support substrate are described. The apparatus includes a light source and a photodetector which can be placed directly into a coating line to provide continuous feedback on the thickness of a fabricated graphene oxide coating, enabling fabrication of controlled thickness coatings and real-time quality monitoring.

### RELATED APPLICATIONS

This application claims priority to and the benefit of U.S. Provisional Patent Application No. 63/287,726, entitled “Apparatus for Characterization of Graphene Oxide Coatings,” filed on Dec. 9, 2021, the disclosure of which is hereby incorporated by reference in its entirety

### GOVERNMENT SUPPORT

This invention was made with U.S. government support under Grant No. 1831203 awarded by the National Science Foundation. The U.S. government has certain rights in the invention.

### TECHNICAL FIELD

The present disclosure generally relates to the characterization of coatings, and more particularly to apparatus and methods for measuring the thickness of coatings containing graphene oxide casted continuously on a moving web.

### BACKGROUND

Real time characterization of the thickness of graphene oxide coatings can facilitate fabrication of high quality and durable materials suitable for a wide range of applications including filters and/or separation membranes used for softening water, desalination, removal and/or purification of small molecules, salts, and/or macromolecules such as proteins. The thickness of graphene oxide coatings can be determined using characterization methods such as Transmission Electron Microscopy (TEM), cross-section Scanning Electron Microscopy (SEM), or Atomic Force Microscopy (AFM). These methods provide thickness measurements that are applicable to very small areas, typically smaller than 1 cm². The above-mentioned microscopy techniques require using expensive and elaborate microscopes operated by highly trained technicians in specialized laboratories. Consequently, the characterization of graphene oxide coating thickness using these microscopy techniques can be costly and time consuming. Additionally, these microscopy techniques may require a number of sample preparation steps in order to obtain accurate and reproducible results. For example, SEM and TEM samples often times require depositing a layer of a conductive material such as silver (Ag) and/or Gold (Au) on to the sample to be imaged in order to ensure high electrical conductivity and avoid charging effects that preclude acquisition of high-resolution images. In some instances, TEM and/or SEM samples may need to be cut using precision instruments such as microtome, in order to generate sharp cross-sectional images. As a result, variations in sample preparation can introduce additional sources of error.

Consequently, there is a need to develop approaches to characterize the thickness of graphene oxide coatings that provide real-time feedback to the graphene oxide coating fabrication process, enabling manufacture of high-quality materials.

### SUMMARY

Apparatus and methods are described herein for measuring the thickness of coatings containing graphene oxide. The apparatus and methods can be used to measure the thickness of graphene oxide coatings casted continuously on a moving web.

In some embodiments, the present disclosure provides an apparatus configured to measure a thickness of a graphene oxide coating on a support substrate. The apparatus comprises a light source and a photodetector. The light source is configured to be positioned on a first side of the support substrate and illuminate the support substrate with incident light. The incident light travels through the support substrate and the graphene oxide coating to exit as transmitted light. The photodetector is configured to be positioned on a second side of the support substrate and measure an intensity of the transmitted light

In some embodiments, the apparatus further comprises a conveyor system configured to move the support substrate in a direction perpendicular to the direction of the incident light, thereby permitting the apparatus to measure the thickness continuously.

In some embodiments, the apparatus further includes a power source that is coupled to the light source. The power source is configured to provide power to the light source.

In some embodiments, the light source has a wavelength in the range of about 200 nm to about 600 nm.

In some embodiments, the light source has a wavelength in the range of about 350 nm to about 600 nm.

In some embodiments, the light source is a light-emitting diode (LED), a laser, a mercury lamp, or a metal halide lamp.

In some embodiments, the apparatus comprises a plurality of light sources.

In some embodiments, the plurality of light sources is arranged in an array.

In some embodiments, the plurality of light sources is arranged in a predetermined or random manner.

In some embodiments, the photodetector is a charge-coupled device (CCD), a photomultiplier, or a photodiode.

In some embodiments, the apparatus comprises a plurality of the photodetectors.

In some embodiments, the plurality of the photodetectors is arranged in an array.

In some embodiments, the plurality of the photodetectors is arranged in a pre-determined or random manner.

In some embodiments, the apparatus further comprises a processor configured to receive data from the photodetector indicative of the intensity of the transmitted light.

In some embodiments, the processor is further configured to analyze the data to determine a relative or absolute thickness of the graphene oxide coating.

In some embodiments, the processor comprises a non-transitory processor-readable medium storing code representing instructions to be executed by the processor. The code can cause the processor to compare the intensity of the transmitted light with a calibration curve, and calculate the absolute thickness based on the calibration curve.

In some embodiments, the apparatus further includes a heat sink coupled to the light source and configured to prevent the light source from overheating.

In an embodiment, the present disclosure provides a method of measuring a thickness of a graphene oxide coating disposed on a support substrate, the method comprising illuminating incident light from a light source onto the support substrate, the incident light traveling through the support substrate and the graphene oxide coating to exit as transmitted light. The method further comprises measuring an intensity of the transmitted light with a photodetector; comparing the intensity of the transmitted light with a reference level; and determining a relative or absolute thickness of the graphene oxide coating based on the comparison.

In some embodiments, the light source has a wavelength in the range of about 200 nm to about 600 nm.

In some embodiments, the light source has a wavelength in the range of about 350 nm to about 600 nm.

In some embodiments, the light source is a light-emitting diode (LED), a laser, a mercury lamp, or a metal halide lamp.

In some embodiments, the photodetector is a charge-coupled device (CCD), a photomultiplier, or a photodiode.

In some embodiments, the reference level is an intensity of transmitted light measured for a control graphene oxide coating having a known thickness. The control graphene oxide coating is disposed on the support substrate.

In some embodiments, the method further includes comparing the relative thickness with a calibration curve; and converting the relative thickness to the absolute thickness based on the calibration curve.

In some embodiments, the support substrate comprises polypropylene, polystyrene, polyethylene, polyethylene oxide, polyethersulfone, polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, polycarbonate, nylon, Kevlar or other aramid, polyether ether ketone, or a combination thereof.

In some embodiments, the support substrate moves in a direction perpendicular to the direction of the incident light. In such embodiments, the method determines the relative or the absolute thickness of the graphene oxide coating continuously.

In an embodiment, the present disclosure provides a method including moving a support substrate disposed on a conveyor system in a first direction. The method further includes illuminating with incident light from a light source a graphene oxide coating disposed on the support substrate. The incident light travels in a second direction perpendicular to the first direction. The incident light travels through the support substrate and the graphene oxide coating to exit as transmitted light. The method further includes measuring an intensity of the transmitted light with a photodetector; receiving, via a processor, data from the photodetector indicative of the measured intensity of the transmitted light; comparing, via the processor, the intensity of the transmitted light with a reference level; and determining continuously, via the processor, a relative or an absolute thickness of the support substrate based on the comparison with the reference level.

In some embodiments, the light source has a wavelength in the range of about 200 nm to about 600 nm

In some embodiments, the reference level is an intensity of transmitted light measured for a control graphene oxide coating having a known thickness, the control graphene oxide coating being disposed on the support substrate

In some embodiments, photodetector is a charge-coupled device (CCD), a photomultiplier, or a photodiode.

### BRIEF DESCRIPTION OF THE DRAWINGS

FIG. 1 is a schematic illustration of an apparatus for determining the thickness of graphene oxide coatings, according to an embodiment.

FIG. 2 is a UV-Vis spectrum of a graphene oxide dispersion.

FIG. 3 is a graph showing light intensity measured with a photodetector across graphene oxide coatings casted on a support substrate, as a function of the concentration of graphene oxide present in the coating solution.

FIG. 4 is a schematic illustration of an apparatus for determining the thickness of graphene oxide coatings, according to an embodiment.

FIG. 5A shows a bottom view schematic illustration of a light source and photodetector of an apparatus for determining the thickness of graphene oxide coatings according to an embodiment, displaying multiple light source devices and photodetector devices installed across the width of a web for casting the graphene oxide coatings.

FIG. 5B shows a top view schematic illustration of a portion of the apparatus for determining the thickness of graphene oxide coatings of FIG. 5A, displaying multiple photodetectors installed across the width of the web for casting the graphene oxide coatings

FIGS. 6A-6C show Scanning Electron Microscope (SEM) images of the cross-sectional area of graphene oxide membranes of different thicknesses.

FIG. 7 is a graph showing the intensity of transmitted light (e.g., light intensity in counts) measured by a photodetector across graphene oxide coatings of different thickness plotted against the thickness of the graphene oxide coatings as determined from SEM images.

### DETAILED DESCRIPTION

The embodiments described herein relate generally to devices for measuring the thickness of coatings, and more specifically to an apparatus for characterizing in real time the thickness of graphene oxide coatings deposited and/or casted onto a support substrate.

Advancements in material science have placed added emphasis on the fabrication of coatings that incorporate novel materials such as graphene oxide. Graphene oxide is an oxidized form of graphene, which is a single atomic layer of carbon atoms that exhibits several exceptional electrical, mechanical, optical, and electrochemical properties. Graphene oxide is a material that has been explored for its use in membranes for filtration applications, due to its low cost, high chemical stability, strong hydrophilicity, and compatibility with a wide variety of environments.

Graphene oxide membranes can be fabricated by preparing a graphene oxide solution and depositing, casting and/or shaping the graphene oxide solution on a support substrate using a suitable coating technique such as a roll coating, spraying, tape casting, and/or flow coating. The fabrication of high-quality graphene oxide membranes for filtration applications requires careful control of the graphene oxide coating thickness to ensure uniform thickness and minimize/avoid pinholes or other defects. Current methodologies to characterize the thickness of graphene oxide coatings involve obtaining small samples of a previously fabricated graphene oxide coating and imaging cross-sectional areas of the obtained samples using a microscopy technique such as Scanning Electron Microscopy (SEM), Atomic Force Microscopy (AFM), and/or Transmission Electron Microscopy (TEM). The need for a finished graphene oxide coating in order to determine its thickness precludes the possibility of real time thickness characterization of graphene oxide coatings during its fabrication process, and thus limits the ability of adjusting and/or tuning the fabrication process conditions to ensure production quality graphene oxide coatings.

Systems, devices, and methods described herein address the limitations of existing techniques by providing an approach for measuring the thickness of graphene oxide coatings deposited on support substrates, allowing real time characterization of the graphene oxide coatings in multiple areas or regions, providing feedback to the graphene oxide coating process, and ultimately ensuring the fabrication of high-quality graphene oxide coatings having uniform thickness.

The embodiments described herein can be configured to determine the thickness of graphene oxide coatings disposed on a support substrate, enabling the continuous measurement of the thickness of graphene oxide coatings on a coating line, and providing real-time feedback of the graphene oxide coating process. In some embodiments, the graphene oxide coatings can be similar to and/or substantially the same as any of those described in International Patent Application Number PCT/US2022/078051, entitled Filtration Apparatus Containing Alkylated Graphene Oxide Membrane,” filed Oct. 13, 2022, U.S. Pat. No. 11,123,694 entitled “Filtration Apparatus Containing Graphene Oxide Membrane,” filed May 28, 2020, and U.S. Pat. No. 11,097,227 entitled “Durable Graphene Oxide Membranes,” filed May 29, 2020, the disclosures of which are incorporated herein by reference in its entirety.

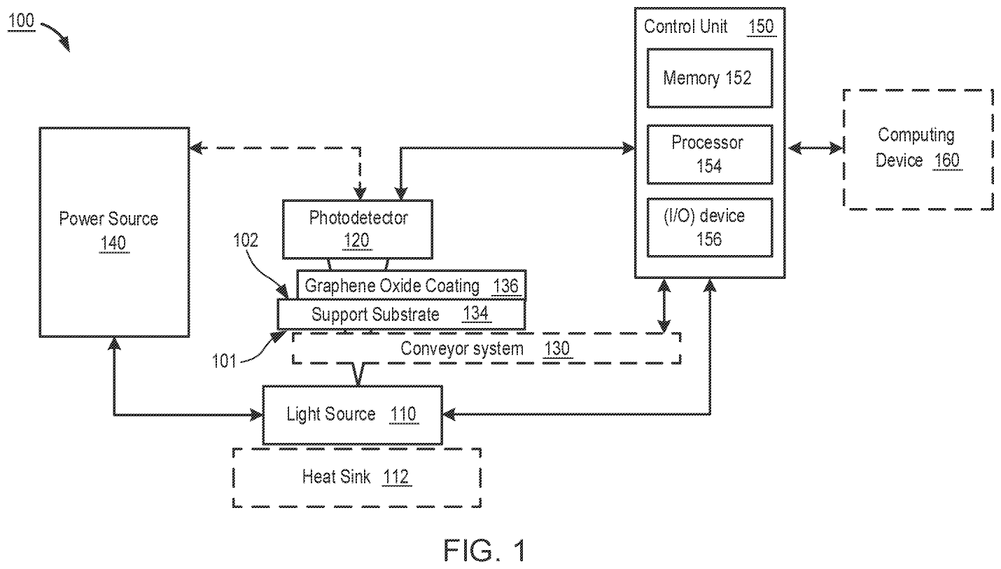

Referring now to the drawings, FIG. 1 is a schematic illustration of an apparatus 100 for determining the thickness of graphene oxide coatings according to an embodiment. The apparatus 100 can include a light source 110, a photodetector 120, a power source 140, and a control unit 150. Optionally, in some embodiments the apparatus 100 can also include a heat sink 112, a conveyor system 130, and a computing device 160, as further described herein. A support substrate 134 and a graphene oxide coating 136 can be positioned between the light source 110 and the photodetector 120, which are coupled to the control unit 150 for operation and data recording and/or analysis, as further described herein.

The light source 110 can be configured to produce, generate, and/or emit light (e.g., a beam of light) which can illuminate, penetrate/and or and travel across a graphene oxide coating deposited over a support substrate with the purpose of determining the thickness of the graphene oxide coating. The light source 110 can be any suitable device configured to produce and/or emit a beam of light. For example, in some embodiments the light source 110 can include a light emitting diode (LED), a laser, a broadband light source (e.g., a mercury lamp, a halogen lamp, a metal halide lamp, an incandescent lamp, a fluorescent lamp or the like). When a broadband light source is used, the apparatus 100 can further include a filter configured to filter the light produced by the light source 110 and produce a narrow band of light. The light source 110 can be electrically coupled to the power source 140 in order to receive power (e.g., an electrical current and/or voltage) suitable for generating and/or emitting a beam of light. The light source 110 can also be coupled to the control unit 150 for activating and/or controlling the operation of the light source 110 and the apparatus 100.

As shown in FIG. 1, in some embodiments, the light source 110 can be disposed on a first side 101 of the support substrate 134 (e.g., under the conveyor system 130), and can be configured to generate light and illuminate the first side 101 of the support substrate 134 with incident light, allowing the incident light to penetrate and travel across the support substrate 134, a graphene oxide coating 136 disposed on the support substrate 134, and then exit the graphene oxide coating 136 as transmitted light. Alternatively, in other embodiments, the light source 110 can be disposed on a second side 102 of the support substrate 134, with the second side 102 being opposite to the first side 101, as shown in FIG. 1. In such embodiments, the light source 110 can be configured to illuminate the second side 102 of the support substrate 134 with incident light, allowing the incident light to penetrate and/or travel across the graphene oxide coating 136, the support substrate 134 adjacent to the graphene oxide coating 136, and then exit as transmitted light. The light source 110 is not disposed on the support substrate 134. Rather, the light source 110 is spaced away from the support substrate 134 at a suitable distance. For example, in some embodiments the light source 110 can be spaced away from the support substrate 134 a distance of no more than about 50 cm, no more than about 45 cm, no more than about 40 cm, no more than about 35 cm, no more than about 30 cm, no more than about 25 cm, no more than about 20 cm, no more than about 15 cm, no more than about 10 cm, no more than about 5 cm, no more than about 2 cm, or no more than about 1 cm, inclusive of all values and ranges therebetween. In embodiments the light source 110 can be spaced away from the support substrate 134 a distance of at least about 1 cm, at least about 2 cm, at least about 4 cm, at least about 6 cm, at least about 8 cm, at least about 10 cm, at least about 14 cm, at least about 18 cm, at least about 22 cm, at least about 26 cm, at least about 30 cm, at least about 34 cm, at least about 38 cm, at least about 42 cm, at least about 46 cm, or at least about 50 cm, inclusive of all values and ranges therebetween.

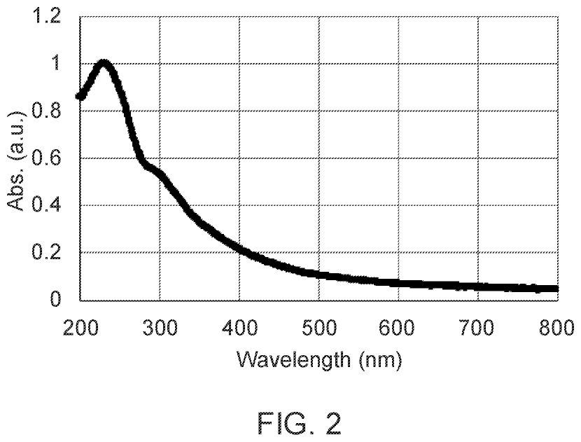

The wavelength of the light source 110 can have a direct impact on the intensity of the light transmitted through the graphene oxide coating 136, as graphene oxide can absorb radiation in the ultraviolet and blue regions of the electromagnetic spectrum (see FIG. 2). Consequently, the light source 110 can be configured to produce and/or emit light of a wavelength or range of wavelengths in which graphene oxide absorb an amount of light that is suitable for detecting changes on the thickness of a graphene oxide coating 136 due to absorption of the light by the graphene oxide coating 136. Additionally, the light source 110 can be configured to produce and/or emit light of a wavelength or range of wavelengths at which the graphene oxide coating 136 does not absorb the light excessively to prevent a majority of the incident light from being absorbed by the graphene oxide coating 136. FIG. 2 shows a UV-vis absorbance spectrum of a graphene oxide dispersion, displaying the amount of light absorbed as a function of the light wavelength. According to FIG. 2, a wavelength or a range of wavelengths between about 200 nm and about 600 nm (e.g., between 350 nm and 600 nm) exhibits a suitable amount of absorbance for determining the thickness of graphene oxide coatings using the apparatus 100.

To select the proper wavelength for the incident light, another consideration is the absorbance spectrum of the support substrate 134, and the scattering properties of the support substrate 134. In some embodiments, the incident light is minimally absorbed by the support substrate 134, e.g., less than 10%, less than 5%, less than 1%, less than 0.5%, or less than 0.1% of the incident light is absorbed by the support substrate 134. In some embodiments, the incident light is minimally scattered by the support substrate 134, e.g., less than 10%, less than 5%, less than 1%, less than 0.5%, or less than 0.1% of the incident light is scattered by the support substrate 134.

In some embodiments, the light source 110 can be configured to produce and/or emit light having a predetermined wavelength or a range of wavelengths. For example, in some embodiments, the light source 110 can be configured to produce and/or emit light having a wavelength of about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, or about 600 nm, inclusive of all values and ranges therebetween.

In some embodiments, the light source 110 can include a single light source device configured to produce a single light beam. The light source device can illuminate a point and/or region of a side of the support substrate 134 to evaluate the thickness of the graphene oxide coating 136 at that point and/or region. In some embodiments, the light source 110 can include multiple light source devices configured to produce multiple light beams. The multiple light source devices can illuminate a plurality of points and/or regions of a side of the support substrate 134 to evaluate the thickness of the graphene oxide coating 136 at those multiple points and/or regions. In some implementations, the light source 110 can include multiple light source devices organized and/or positioned randomly to illuminate a side of the support substrate 134 at randomly distributed points and/or regions and evaluate the thickness of the graphene oxide coating 136 at those randomly distributed points. In other implementations, the light source 110 can include multiple light source devices organized and/or positioned forming an array (e.g., a matrix and/or a predetermined pattern) to illuminate a side of the support substrate 134 at points and/or regions forming the predetermined array or pattern: and evaluate the thickness of the graphene oxide coating 136 at those points. For example, in some implementations, the light source 110 can include 6 light source devices organized and/or positioned forming a 2×3 matrix on one side of the support substrate 134. The light source devices can illuminate the support substrate 134 at a plurality of points and/or regions forming the 2×3 matrix; and evaluate the thickness of the graphene oxide coating 136 at those 2×3 matrix points. In other implementations, the light source 110 can include multiple light source devices organized and/or positioned along a line perpendicular to the direction of casting of the graphene oxide coating 136. The light source devices can illuminate a side of the support substrate 134 to evaluate the thickness of the graphene oxide coating 136 and generate a cross-web thickness profile of the graphene oxide coating 136, as further described herein. In some implementations, the light source 110 can include multiple light source devices, with a first portion of the light source devices configured to be organized and/or positioned on a first side of the support substrate 134 (e.g., the first side 101 of the support substrate), and a second portion of the light source devices configured to be organized and/or positioned on the second side of the support substrate 134 (e.g., the second side 102 of the support substrate) opposite to the first side. In some embodiments, the light source 110 can include one or more light source devices organized and/or positioned such that the light source devices produce and/or emit incident light that propagates following a path that is perpendicular to the direction in which the support substrate 134 moves on the conveyor system 130, as further described herein.

In some embodiments, the light source 110 can include a heat sink 112 mechanically coupled to the light source 110. The heat sink 110 can be any suitable structure or device configured to remove and/or dissipate heat generated by the light source 110. For example, in some embodiments, the heat sink 112 can include a fin, or an array of fins (e.g., a passive heat sink). The fins can be made of one or more materials having high thermal conductivity. For example, in some embodiments, the heat sink 112 can be made of aluminum, aluminum alloys, copper, and/or synthetic diamond. In some embodiments, the heat sink 112 can include a fan, a blower, a jacket, and/or a jacket (e.g., an active heat sink). In such embodiments, the heat sink 112 is configured to circulate a fluid having high heat capacity such as water, nitrogen, and/or air to remove and/or dissipate heat generated by the light source 110. In some embodiments, the heat sink 112 can a combination of active heat sinks and passive heat sinks.

The photodetector 120 can be an optical light detector configured to detect and/or measure an intensity of the light transmitted through the support substrate 134 and the graphene oxide coating 136. The photodetector 120 can be any suitable optical light detector device including a charge-coupled device (CCD), a photomultiplier, and a photodiode. The photodetector 120 can be coupled to the control unit 150 for activating and/or controlling the operation of the photodetector 120, and to transmit the intensities of the light detected and/or measured by the photodetector 120, as further described herein. In some embodiments, the photodetector 120 can also be coupled to the power source 140 in order to receive power (e.g., an electrical current and/or voltage) suitable for operating the photodetector.

In some embodiments, the photodetector 120 can be positioned on a side of the support substrate 134 that is opposite to the side of the support substrate 134 that the light source 110 is configured to illuminate. The photodetector 120 is not physically on the support substrate 134. Rather, the photodetector 120 is spaced away from the support substrate 134 at a suitable distance. For example, in some embodiments, such as those shown in FIG. 1, the light source 110 can be positioned on the side 101 of the support substrate 134 while the photodetector 120 is positioned on the side 102 of the support substrate 134. Alternatively, in other embodiments (not shown), the light source 110 can be positioned on the side 102 of the support substrate 134 while the photodetector 120 is positioned on the side 101 of the support substrate 134.

In some embodiments the photodetector 120 can include a single photodetector device. The photodetector device can be configured to detect and/or measure an intensity of a light generated by a single light source 110 and transmitted through the support substrate 134 and the graphene oxide coating 136. The intensity of the light measured by the photodetector device can be used to determine the thickness of the graphene oxide coating 136, as further described herein. In some embodiments, the photodetector 120 can include multiple photodetector devices configured to detect and/or measure the intensities of a plurality of lights generated by the light source 110 and transmitted through the support substrate 134 and the graphene oxide coating 136 at multiple points and/or regions. The intensities of the plurality of lights measured by the photodetector devices can be used to determine the thickness of the graphene oxide coating 136 at those multiple points and/or regions. In some implementations, the photodetector 120 can include multiple photodetector devices organized and/or positioned to reflect and/or mirror the positions of the light source devices of the light source 110. In such embodiments, each photodetector device is positioned on one side of the support substrate 134 to detect and/or measure the highest amount of light generated by a light source device of the light source 110 positioned on the opposite side of the support substrate 134 and transmitted through the support substrate 134 and the graphene oxide coating 136 at a point and/or region. The intensity of the light measured by the photodetector can then be used to determine the thickness of the graphene oxide coating 136 at that point and/or region. For example, in some implementations, the photodetector 120 can include multiple photodetector devices positioned on one side of the support substrate 134 such that they correspond to and/or mirror a randomly distributed plurality of light sources positioned on the opposite side of the support substrate 134. The intensities of the lights measured by the photodetector devices can be used to determine the thickness of the graphene oxide coating 136 at the positions and/or regions illuminated by the light source 110. In some implementations the photodetector 120 can include multiple photodetector devices positioned on one side of the support substrate 134 such that they correspond to and/or mirror a 2×3 matrix of light sources positioned on the opposite side of the support substrate 134. The intensities of the lights measured by the photodetector devices can be used to determine the thickness of the graphene oxide coating 136 at the 2×3 matrix positions and/or regions illuminated by the light source 110. In some implementations the photodetector 120 can include multiple photodetector devices positioned on one side of the support substrate 134 such that they correspond to and/or mirror a line of light sources positioned on the opposite side of the support substrate 134, with the line of light sources being perpendicular to the direction of casting of the graphene oxide coating 136. The intensities of the lights measured by the photodetector devices can be used to determine the thickness of the graphene oxide coating 136 at the line positions and/or regions illuminated by the light source 110.

The conveyor system 130 can be any suitable structure configured to receive and/or accommodate the support substrate 134 and move the support substrate 134 along a direction. For example, in some embodiments the conveyor system 130 can include a roll-to-roll coating line, a belt conveyor, a belt driven, a live roller conveyor system, a drag conveyor, a chain conveyor, a flexible conveyor or the like. The conveyor system 130 can be configured to transport the support substrate 134 along a direction to facilitate continuously depositing and/or casting a graphene oxide coating 136 on one side of the support substrate 134. For example, in some embodiments, the conveyor system can be coupled to a stationary reservoir and/or a coating head (not shown) containing a solution or suspension of the graphene oxide coating 136. The stationary reservoir can have an opening and/or outlet from which the solution or suspension of the graphene oxide coating 136 can flow out of the stationary reservoir and be deposited on one side of the support substrate 134 being moved in one direction (e.g., the casting direction) by the conveyor system.

The conveyor system 130 can be coupled to the control unit 150 for activating and/or controlling the operation of the conveyor system 130. In some embodiments, the conveyor system 130 can be configured to move the support substrate 134 at a speed that can be adjusted via the control unit 150. In such embodiments, the speed at which the conveyor system 130 moves the support substrate 134 can be changed and/or adjusted to facilitate deposition of a graphene oxide coating 136, or to facilitate measuring the thickness of a casted graphene oxide coating 136. For example, in some embodiments, the conveyor system 130 can be configured to move the support substrate 134 at a first speed for a predetermined amount of time, or until the support substrate 134 has been moved a predetermined distance and/or a graphene oxide coating 136 has been deposited on the support substrate 134. Then the conveyor system 130 can be configured to transport and/or move the support substrate 134 at a second speed for a period of time. The operation of the conveyor system 130 at the second speed can facilitate illuminating one side of the support substrate 134 with the light source 110 and (2) detecting and/or measuring an intensity of the light transmitted through the support substrate 134 and the graphene oxide coating 136 with the photodetector 120. Then, the intensities of the light transmitted through the support substrate 134 and the graphene oxide coating 136 can be used to determine the thickness of the graphene oxide coating 136, as further described herein.

In some embodiments the conveyor system 130 can be configured move the support substrate 134 at a speed to facilitate casting of a graphene oxide coating 136 on one side of the support substrate 134 and simultaneously measuring the thickness of the casted graphene oxide coating 136 (e.g., continuously casting the graphene oxide coating 136 and monitoring the thickness of the casted graphene oxide coating 136). In such implementations, the conveyor system 130 can be configured to transport and/or move the support substrate 134 at a speed which is sufficiently high for disposing and/or casting the graphene oxide coating 136 on the support substrate 134 and at the same time sufficiently low to illuminating a spot and/or region of the support substrate 134 and measure the intensity of the transmitted light to determine the thickness of the graphene oxide coating 136. In some embodiments, the conveyor system 130 can be placed and/or positioned above the light source 110 to illuminate a point and/or region of the side 101 of the support substrate 134, as shown in FIG. 1. In such embodiments, the conveyor system 130 can be configured to allow a beam of light to pass through and illuminate a point and/or region of the side 101 of the support substrate 134. For example, in some embodiments, the conveyor system 130 can include a roll-to-roll coating line comprising multiple rollers over which the support substrate 134 can be directly suspended (e.g., floating between the rollers). In some embodiments the conveyor system 130 can include two pulleys and a belt that rotates around the two pulleys in a closed loop. The belt can be made of a fabric or any other suitable material that includes multiple openings or holes that allow the light source 110 to illuminate the support substrate 134 to determine the thickness of a graphene oxide coating 136 casted on the support substrate 134. In some embodiments, the direction of movement of the support substrate 134 can be perpendicular to the direction and/or path of propagation of the light produced and/or emitted by the light source 110.

The power source 140 can store energy to power one or more components of the apparatus 100. The power source 140 can be any suitable energy source and/or energy storage device. For example, in some embodiments, the power source 140 can include one or more rechargeable batteries configured to provide a DC current to the light source 110, which can be used to produce and/or emit a light beam. In some embodiments, the apparatus 100 can include one or more ports that enable connection between an external power source and one or more components of the apparatus 100. The external power source can be used to directly power the components of the apparatus 100 and/or recharge the power source 140. For example, in some embodiments the power source 140 can be coupled to the conveyor system 130 to provide AC electrical power to the conveyor system 130 for moving the support substrate 134.

The control unit 150 can be configured to activate and/or control the operation of one or more components of the apparatus 100, e.g., by receiving electrical signal(s) from and/or sending electrical signal(s) to other components of the apparatus 100. The control unit 150 can include a memory 152, a processor 154, and an input/output (I/O) device 156.

The memory 152 can be, for example, a random-access memory (RAM), a memory buffer, a hard drive, a database, an erasable programmable read-only memory (EPROM), an electrically erasable read-only memory (EEPROM), a read-only memory (ROM), and/or so forth. In some embodiments, the memory 152 stores instructions that cause the processor 154 to execute modules, processes, and/or functions associated with operating one or more components of the apparatus 100. Such instructions can be designed to integrate specialized functions into the control unit 150, such that the apparatus 100 can perform methods, as further described below.

The processor 154 of the control unit 150 can be any suitable processing device configured to run and/or execute functions associated the apparatus 100. For example, the processor 154 can be configured to process and/or analyze data received from the photodetector 120 to determine the thickness of the graphene oxide coating 136, to adjust one or more parameters of the light source 110 (e.g., the intensity of the light produced and/or emitted by the light source 110, the frequency with which the light source 110 illuminates the support substrate 134, etc.), and to generate feedback and/or instructions to adjust and/or change the speed of the conveyor system 130. The processor 154 can be a general-purpose processor, a Field Programmable Gate Array (FPGA), an Application Specific Integrated Circuit (ASIC), a Digital Signal Processor (DSP), and/or the like.

The input/output (I/O) device 156 include one or more components for receiving information and/or sending information to other components of apparatus 100 and/or other devices. In some embodiments, the I/O device 156 can optionally include or be operatively coupled to a display, audio device, or a computer device 160 for presenting information to a user, as shown in FIG. 1. In some embodiments, the I/O device 156 can include a communication interface that can enable communication between control unit 150 and the light source 110, the photodetector 120, the conveyor system 130, and the power source 140. In some embodiments the I/O device 156 can include a network interface (not shown) that can enable communication between control unit 150 and one or more external devices, including, for example, an external user device (e.g., a mobile phone, a tablet, a laptop) and/or the computing device 160 (e.g., a local or remote compute, a server, etc.). The network interface can be configured to provide a wired connection with the one or more external devices, e.g., via a port or firewall interface, or alternatively, can be configured to communicate with the external device via a wireless network (e.g., Wi-Fi, Bluetooth®, low powered Bluetooth®, Zigbee and the like). In some embodiments, the communication interface can also be used to recharge a power source (e.g., the power source 140), e.g., a rechargeable battery.

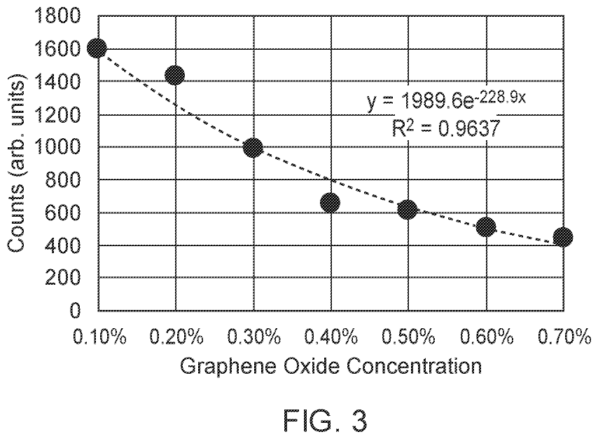

As described above, the apparatus 100 can be used to determine the thickness of graphene oxide coatings disposed over a support substrate 134. In some embodiments, the apparatus 100 can be configured to determine a relative or an absolute thickness of a graphene oxide coating. For example, the apparatus 100 can be used to continuously fabricate a graphene oxide coating 136 by casting a graphene oxide coating solution on the support substrate 134 which is disposed on the conveyor system 130. The conveyor system 130 can be configured to move in a direction at a speed suitable for casting the graphene oxide coating solution and for illuminating the support substrate 134 and the produced graphene oxide coating 136 to determine the thickness of the graphene oxide coating 136. The light source 110 can be configured to illuminate the side 101 of the moving support substrate 134 while the photodetector 120 simultaneously detects and/or measures the intensities of the transmitted light continuously. In that way, the apparatus 100 permits real time characterization of the thickness of graphene oxide coatings deposited and/or casted on the support substrate 134 in a continuous manner. Alternatively, in some implementations the light source 110 can be configured to illuminate the side 101 of the moving support substrate 134 at a predetermined frequency. For example, in some implementations the light source 110 can be configured to illuminate the side 101 of the moving support substrate 134 every 15 seconds or any other suitable time frequency (e.g., 0.5 min, 1, min, 5 min, etc.). The photodetector 120 can be configured to detect and/or measure the intensities of the transmitted light produced every time the light source 110 illuminates the side 101 of the moving support substrate 134. In some embodiments, the light source 110 can include a single light source device that can illuminate a single point and/or region of a side of the support substrate 134. In other embodiments, the light source 110 can include multiple light source device that can illuminate a plurality of points and/or regions of a side of the support substrate 134. Incident light can illuminate a point and/or region of a first side of the support substrate 134. For example, as shown in FIG. 1, incident light can illuminate a point and/or region of a first side 101 of the support substrate 134. The light can penetrate and/or travel through the support substrate 134 and the graphene oxide coating 136 and exit as transmitted light on the surface of the graphene oxide coating 136. The light from the light source 110 is attenuated by absorption and scattering in the support substrate 134 and the graphene oxide coating 136. If the thickness of the support substrate 134 is held constant, then the amount of light attenuation caused by the support substrate 134 is also constant, and variations in the total amount of light attenuation are solely dependent on the thickness of the graphene oxide coating 136. FIG. 3 shows a graph of the transmitted light intensity measured with a photodetector for a plurality of graphene oxide coatings casted on a porous polytetrafluoroethylene (PTFE)/polypropylene (PP) support substrate 134. The thickness of the graphene oxide coatings in FIG. 3 was varied by changing the concentration of graphene oxide in the coating solution between 0.1 wt % and 0.7 wt %. The relationship between optical transmittance and thickness shown in FIG. 3 can be described by Lambert's Law as equation:

I=Iₒe^{-μ(x)}

### Where:

I is the measured intensity

Io is the initial intensity

x is the path length

μ is the coefficient of absorption.

The fit between the experimentally measured data shown in FIG. 3 and Lambert's Law shows that the attenuation of light intensity can be used to determine the absolute or relative thickness of a graphene oxide coating. In order to ensure that the thickness of the support substrate 134 is constant, the support substrate 134 can be made by a robust fabrication process that facilitates the production of support substrates 134 having constant thickness. For example, in some embodiments the support substrate 134 can be made by a fabrication process such as tape casting, spray coating, spin coating, flow coating, roll coating and the like. In some implementations, the support substrate 134 can be characterized with the apparatus 100 to verify the consistency of the support substrate 134 thickness at different positions within one sample of the support substrate 134 and/or between different batches of the support substrate 134 prior to disposing a graphene oxide coating 136 on the support substrate 134. For example, in some implementations the support substrate 134 can be checked for thickness consistency periodically. In other instances, the support substrate 134 can be checked for thickness consistency prior to casting each graphene oxide coating 136. Alternatively, in some implementations, the support substrate 134 can be characterized via conventional thickness measuring techniques and/or devices such as calipers and/or coat weight measuring systems to verify the consistency of the support substrate 134 thickness prior to disposing a graphene oxide coating 136 thereon. In some embodiments, the support substrate 134 can also be made of a material that exhibits low absorption of light such that the incident light produced and/or emitted by the light source 110 is not completely attenuated by the support substrate 134. For example, in some embodiments the support substrate 134 can be made of one or more materials such as polypropylene, polystyrene, polyethylene, polyethylene oxide, polyethersulfone, polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, polycarbonate, nylon, Kevlar or other aramid, polyether ether ketone, or a combination thereof.

The transmitted light can be detected and/or measured by the photodetector 120 and recorded by the control unit 150 and/or the optional computing device 160. The intensity of the transmitted light can then be compared with a reference level and/or reference intensity in order to determine the thickness of the graphene oxide coating. In some embodiments, the reference level can be the intensity of the transmitted light for a control graphene oxide coating 136 of known thickness disposed on the support substrate 134, thus generating a relative thickness of the measured graphene oxide coating. Alternatively, the intensity of the transmitted light can be compared with the intensity of the light used to illuminate the point and/or region of the side 101 of the support substrate 134, to determine the percentage of light attenuation resulting from the light traveling through the support substrate 134 and the graphene oxide coating. The percentage of light attenuation due to the graphene oxide coating 136 measured with the apparatus 100 can then be compared with a reference level of percentage of light attenuation measured with the apparatus 100 with a graphene oxide coating 136 on of known thickness disposed on the support substrate 134 (e.g., the control graphene oxide coating). Thus, the thickness of the graphene oxide coating can be reported as a relative thickness of the measured graphene oxide coating 136.

In some embodiments, a first intensity of the transmitted light measured at a first location of the graphene oxide coating 136 can be compared with a second intensity of the transmitted light measured at a second location, so as to determine the relative thickness of the graphene oxide coating 136 at those locations. For example, if the first intensity is less than the second intensity, then the graphene oxide coating 136 at the first location is thicker than the graphene oxide coating 136 at the second location.

In some embodiments, the thickness of the graphene oxide coatings determined with the apparatus 100 can be combined with a calibration curve in order to obtain the absolute thickness of the graphene oxide coatings. For example, in some embodiments, a calibration curve can be generated by preparing a series of graphene oxide coatings having different thicknesses disposed on the support substrate 134, as further described herein.

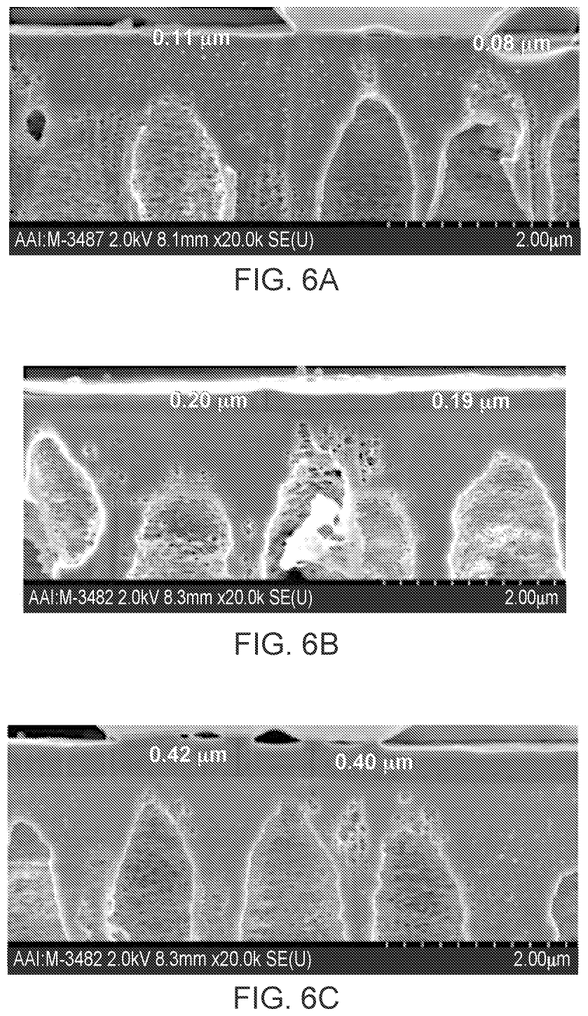

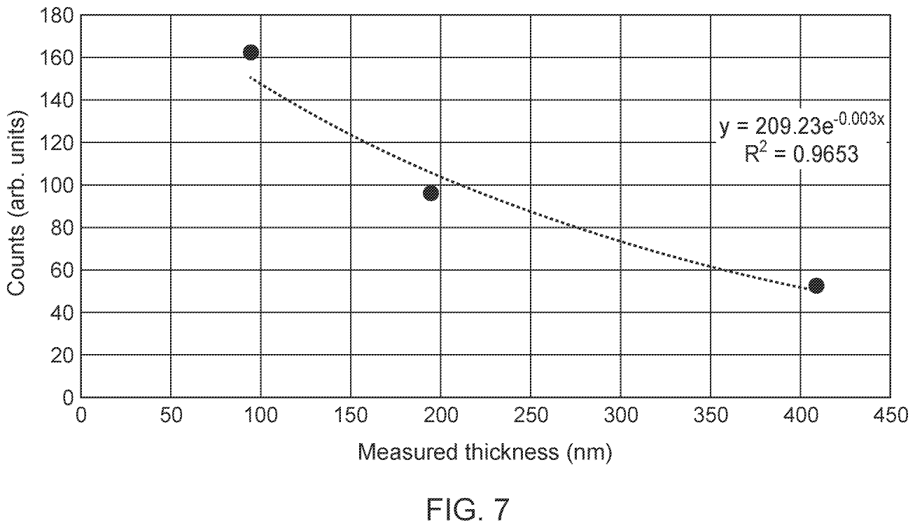

In some instances, graphene oxide coatings having different thickness can be prepared by changing the concentration of graphene oxide present in the graphene oxide coating solution prior to fabricating the graphene oxide coating 136 on the support substrate 134. The absolute thickness of the graphene oxide coatings can be determined using characterization techniques such as SEM, AFM, TEM, Focused ion beam microscopy (FIB) and the like. The apparatus 100 can also be used to measure the light transmitted through the graphene oxide coatings 136 disposed on the support substrate 134, and the intensity of the light transmitted and/or the light attenuation percentage can be combined with the absolute thickness measured to produce a calibration curve. For example, FIGS. 6A-6C show SEM images of three example graphene oxide coatings 136 disposed on a support substrate 134. The SEM images show the cross-sectional area of each graphene oxide coating 136, revealing the thickness of the graphene oxide coatings 136. FIG. 6A shows the cross-sectional area of a first graphene oxide coating 136 which has a thickness of about 410 nm. FIG. 6B shows the cross-sectional area of a second graphene oxide coating 136 which has a thickness of about 195 nm, and FIG. 6C shows the cross-sectional area of a third graphene oxide coating 136 which has a thickness of about 95 nm. The graphene oxide coatings 136 shown in FIGS. 6A-6C can also be analyzed using the apparatus 100 in order to generate a calibration curve. Each one of the graphene oxide coatings 136 can be placed on the apparatus 100 as shown in FIG. 1. The light source 110 can be used to illuminate the side 101 of the support substrate 134 (as shown in FIG. 1) while the photodetector 120 can be used to detect and/or measure the intensity of the light transmitted after penetrating the support substrate 134 and the graphene oxide coating 136. The intensity of the transmitted light measured for each graphene oxide coating 136 can be recorded and then plotted against the thickness of the graphene oxide coating 136 determined with the SEM images, generating and/or producing a calibration curve. FIG. 7. shows an example of such calibration curve. The X-axis of the plot shown in FIG. 7 displays the thickness of the graphene coatings 136 (in nanometers, nm) determined and/or measured from the SEM images of FIGS. 6A-6C, while the Y axis shows the corresponding intensity of the transmitted light (in Counts), measured by the photodetector 120 of the apparatus 100. The data shown in FIG. 7 can be analyzed by any suitable statistical method to determine a calibration curve which correlates the thickness in nm and the intensity of the transmitted light in Counts. FIG. 7 shows an example calibration curve relating the thickness (in nm) of a graphene oxide coating 136 measured via SEM and the corresponding intensity (in Counts) measured with the apparatus 100. In some embodiments, such as that shown in FIG. 7, the calibration curve can correspond to an exponential equation which resembles Lambert's Law equation described above. In some embodiments, the calibration curve can assume any suitable mathematical equation and/or relation including, for example, linear, polynomial, logarithm, and the like.

In use, the calibration curve shown in FIG. 7 can be used to determine the thickness of a graphene oxide coating 136 of unknown thickness disposed on a support substrate 134. The graphene oxide coatings 136 of unknown thickness can be placed on the apparatus 100 as shown in FIG. 1. The light source 110 can be used to illuminate the side 101 of the support substrate 134 (as shown in FIG. 1) while the photodetector 120 can be used to detect and/or measure the intensity of the light transmitted after penetrating the support substrate 134 and the graphene oxide coating 136 of unknown thickness. Alternatively, in some embodiments in which the light source 110 is disposed above the conveyor system 130 and the photodetector 120 is disposed below the conveyor system 130, the light source 110 can be used to illuminate the graphene oxide coating 136 while the photodetector 120 can be used to detect and/or measure the intensity of the light transmitted after penetrating the graphene oxide coating 136 of unknown thickness and the support substrate 134. The intensity of transmitted light in counts (or in any other suitable measuring unit) measured by the photodetector 120 can then be used with the calibration curve to calculate and/or determine a corresponding thickness in nanometers (or in any other suitable measuring unit) of the graphene oxide coating 136 of unknown thickness. In some embodiments, an operator can manually read the intensity of the of transmitted light and calculate and/or determine a thickness of the graphene oxide coating 136 of unknown thickness using the mathematical expression of the calibration curve. Alternatively, in some embodiments the processor 154 of the control unit 150 can be configured to receive signals from the photodetector 120, with the signals being indicative of the intensity of the transmitted light measured by the photodetector after penetrating the support substrate 134 and the graphene oxide coating 136 of unknown thickness. The processor 154 can be further configured to analyze the received intensity of the transmitted light and use a calibration curve such as the calibration curve shown in FIG. 7, to calculate and/or determine a thickness of the graphene oxide coating 136 of unknown thickness.

In some embodiments, data representative of the intensity of the light transmitted through the graphene oxide coating 136 and measured by the photodetector 120 can be received by the processor 152. In some instances, the processor 152 can be configured to analyze the received data and compare it to the light transmitted with a reference level to determine a relative thickness of the graphene oxide coating 136 as described above. In other instances, the processor 152 can be configured to analyze the received data, compare it to the light transmitted with graphene oxide samples corresponding to a calibration curve, and calculate, based on the comparison, the absolute thickness of the graphene oxide coating 136 measured with the apparatus 100, as described above.

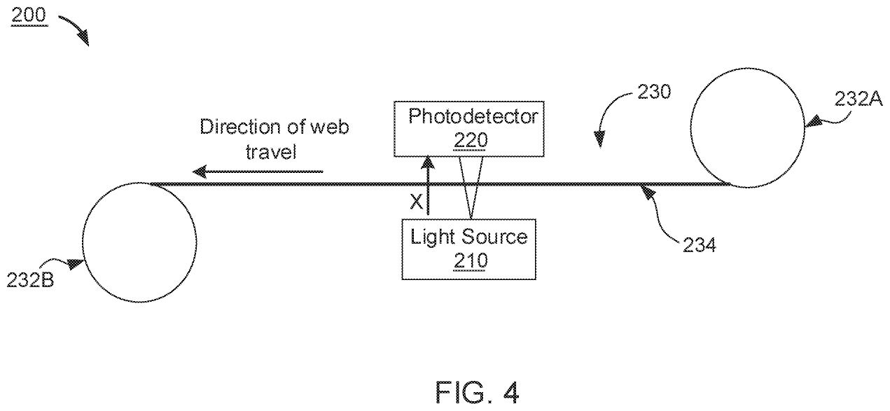

FIG. 4 shows a schematic illustration of an apparatus 200 for determining the thickness of graphene oxide coatings, according to an embodiment. The apparatus 200 can be similar to and/or substantially the same as one or more portions (and/or combination of portions) of the apparatus 100 described above with reference to FIG. 1. More specifically, the apparatus 200 can be substantially similar in at least form and/or function to the apparatus 100 described in detail above. Thus, portions and/or components of the apparatus 200 may not be described in further detail herein. The apparatus 200 includes a light source 210, a photodetector 220, and a conveyor system 230. The apparatus 200 can also include an optional power source 240 (not shown), and an optional control unit 250 (not shown). The light source 210 can be any suitable device configured to produce and/or emit a beam of light. For example, in some embodiments the light source 210 can include an LED, a laser, a mercury lamp, a halogen lamp, a metal halide lamp, an incandescent lamp, a fluorescent or the like. The light source 210 can be positioned under a support substrate 234 of the conveyor system 230 such that the light produced and/or emitted by the light source 110 propagates in a direction X that is perpendicular to the direction of movement of the support substrate 234 (i.e., the direction of web travel).

The photodetector 220 can be any suitable optical light detector device including a charge-coupled device (CCD), a photomultiplier, and/or a photodiode. The photodetector 220 can be positioned at a side of the support substrate 234 that is opposite to the side of the support substrate 234 that the light source 210 is configured to illuminate. Said in other words, the support substrate 234 and the graphene oxide coatings can be positioned on the conveyor system 230 between the light source 210 and the photodetector 220, facilitating illumination of the support substrate 234 and the graphene oxide coatings in the direction X of light propagation.

The conveyor system 230 can be configured to move the support substrate 234 at a speed to facilitate casting of a graphene oxide coating on one side of the support substrate 234 and simultaneously measuring the thickness of the casted graphene oxide coating (e.g., continuously casting the graphene oxide coating and monitoring the thickness of the casted graphene oxide coating). The conveyor system 230 can be any suitable type of conveyor system. For example, in some embodiments, the conveyor system 230 can include a roll-to-roll coating line comprising multiple rollers over which the support substrate 234 can be directly suspended (e.g., floating between the rollers) and moved and/or transported at a speed suitable for continuously depositing a graphene oxide coating. FIG. 4 shows such a conveyor system 230 which includes a first roller 232A over which a roll of the support substrate 234 is unwound and then moved and/or transported towards a coating head (not shown) to dispense the graphene oxide coating, and a second roller 232B configured to re-wind the support substrate 234 after the graphene oxide coating has been coated on the support substrate 234. In some embodiments, the conveyor system 230 can include additional rollers between the first roller 232A and the second roller 232B to control characteristics such as the tension of the support substrate 234, and its alignment. In some embodiments, the conveyor system 230 can include other rollers over which the support substrate 234 is suspended such that it can be subjected to various fabrication steps. For example, in some embodiments, the conveyor system 230 can include a web pre-treatment roller, a backing roller, a lamination roller, a calendaring roller, and/or a drying, curing and/or annealing roller (e.g., one or more rollers used to direct the support substrate 234 through a furnace and/or heating system designed to dry, cure and/or anneal the support substrate 234).

The apparatus 200 can be used to determine the thickness of graphene oxide coatings disposed over a support substrate 234. For example, the apparatus 200 can be used to continuously fabricate a graphene oxide coating by casting a graphene oxide coating solution on the support substrate 234 which is disposed on the conveyor system 230. The conveyor system 230 can be configured to move in a direction at a speed suitable for casting the graphene oxide coating and for illuminating the support substrate 234 and the graphene oxide coating to determine the thickness of the graphene oxide coating. The light source 210 can be configured to illuminate a first side of the moving support substrate 234 while the photodetector 220 simultaneously detects and/or measures the intensity of the transmitted light on a second surface of the support substrate 234 adjacent to the graphene oxide coating. Incident light can illuminate a point and/or region of the first side of the support substrate 234. The light can penetrate and/or travel through the support substrate 234 and the graphene oxide coating and exit as transmitted light on the surface of the graphene oxide coating, where it is measured by the photodetector 220. In some embodiments, the conveyor system 230 can be coupled to a control unit (not shown) to activate and/or control the operation of the rollers 230A and 230B. The control unit can enable communication with a one or more external devices such that a user can adjust the speed of rotation of the rollers 230A and 230B to control the speed at which the conveyor system 230 moves the support substrate 234 and the casted graphene oxide coating in the direction of web travel. In that way, a user can introduce a set of instructions to adjust the speed of the conveyor system 230, facilitating casting the graphene oxide coating and measuring the thickness of the casted graphene oxide coating. For example, in some embodiments, a user can establish a speed for the conveyor system 230 suitable for casting a graphene oxide coating (e.g., a casting speed). In some embodiments the casting speed can be no more than about 3,000 feet per minute, no more than about 2,000 foot per minute, no more than about 1,000 feet per minute, no more than about 800 feet per minute, no more than about 500 feet per minute, no more than about 250 feet per minute, no more than about 150 feet per minute, no more than about 100 feet per minute, no more than about 50 feet per minute, no more than about 20 feet per minute or no more than about 10 feet per minute, inclusive of all values and ranges therebetween. In some embodiments, the casting speed can be at least about 10 feet per minute, at least about 20 feet per minute, at least about 40 feet per minute, at least about 80 feet per minute, at least about 100 feet per minute, at least about 200 feet per minute, at least about 400 feet per minute, at least about 600 feet per minute, at least about 1000 feet per minute, at least about 2000 feet per minute or at least about 3000 feet per minute, inclusive of all values and ranges therebetween. Combinations of the above referenced casting speeds for moving the conveyor system 230 are also possible (e.g., a casting speed of at least about 10 feet per minute to no more than about 2000 feet per minute, at least about 500 feet per minute to no more than about 1500 feet per minute).

In some implementations, the conveyor system 230 can be operated at the casting speed for a period of time to facilitate the casting and subsequent measurement of the thickness of the graphene oxide coating for a predetermined length of graphene oxide coating casted on the support substrate 234. In some implementations, the conveyor system 230 can be operated at a first speed selected to rapidly characterize the thickness of the support substrate 234 prior to depositing a graphene oxide coating. The conveyor system 230 can subsequently be operated at a second speed (e.g., the casting speed) to deposit a graphene oxide coating on the support substrate 234. For example, in some implementations the conveyor system 230 can operate at the first speed moving the support substrate 234 in a first direction to facilitate the rapid characterization of the thickness of the support substrate 234. The conveyor system 230 can then be transitioned to operate at the casting speed moving the support substrate 234 in a second direction, the second direction being opposite to the first direction (e.g., reversing the direction of rotation of the rollers), to facilitate the casting and subsequent measurement of the thickness of the graphene oxide coating on the support substrate 234. Alternatively, in some implementations, a roll of the support substrate 234 can be coupled to the first roller of the conveyor system 230. The conveyor system 230 can then be operated at the first speed to rapidly characterize the thickness of the support substrate 234, resulting in a substantial portion of the support substrate 234 being rewound in the second roller. Subsequently, the roll of support substrate 234 can be removed from the second roller and re-coupled to the first roller. The conveyor system 230 can then be operated at the casting speed to facilitate the casting and subsequent measurement of the thickness of the graphene oxide coating on the support substrate 234.

The light transmitted on the surface of the graphene oxide coating and detected and/or measured by the photodetector 220 can be recorded by a control unit (not shown) and/or an optional computing device (not shown). The intensity of the light transmitted on the surface of the graphene oxide coating can then be compared with a reference level in order to determine the thickness of the graphene oxide coating. Without reiterating, the methods for determining the absolute or relative thickness of the graphene oxide coatings using the apparatus 200 are the same or substantially the same as those described above in relation to the apparatus 100.

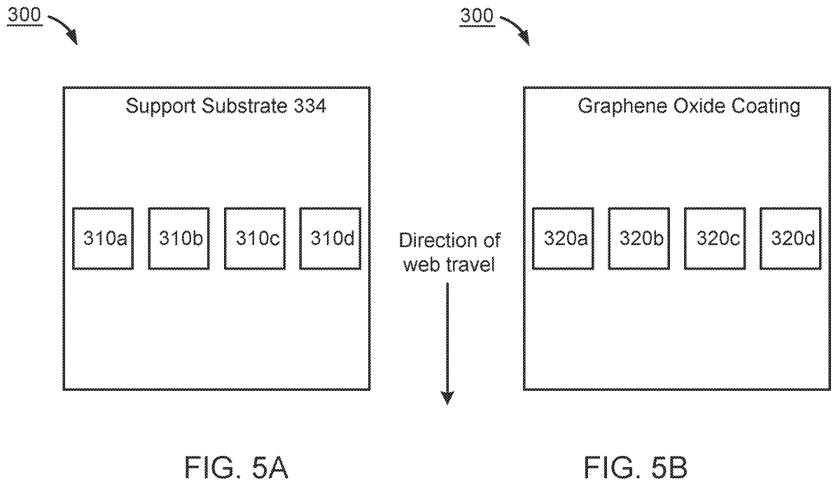

FIGS. 5A-5B shows a schematic illustration of a light source 310 and a photodetector 320 of an apparatus 300 for determining the thickness of graphene oxide coatings, according to an embodiment. The apparatus 300 can be similar to and/or substantially the same as one or more portions (and/or combination of portions) of the apparatus 100 and 200 described above with reference to FIG. 1 and FIG. 4. More specifically, the apparatus 300 can be substantially similar in at least form and/or function to the apparatus 100 and apparatus 200 described in detail above. Thus, portions and/or components of the apparatus 300 may not be described in further detail herein. FIG. 5A shows a bottom view schematic illustration of a portion of the apparatus 300, displaying the light source 310. The light source 310 comprises multiple light source devices 310a, 310b, 310c, and 310d which are organized and/or positioned along a line perpendicular to the direction of casting of the graphene oxide coating (e.g., the direction of web travel). The light source devices 310a-310d can be configured to illuminate a first side of a support substrate 334 to evaluate the thickness of the graphene oxide coating and generate a graphene oxide coating cross section thickness profile, as further described herein.

FIG. 5B shows a top view schematic illustration of a portion of the apparatus 300, displaying the photodetector 320. The photodetector 320 includes multiple photodetector devices 320a, 320b, 320c, and 320d which are organized and/or positioned on a second side of the support substrate 334 which is opposite to the first side of the support substrate 334 and adjacent to the graphene oxide coating. The photodetector devices 320a-320d are positioned such that they can detect and/or measure the transmitted light on the surface of the graphene oxide coating corresponding to the incident light directed by the light source devices 310a-310d. For example, the photodetector device 320a can be positioned such that the photodetector device 320a can detect and/or measure transmitted light on the surface of the graphene oxide coating corresponding to the incident light produced and/or emitted by the light source device 310a. In some instances, the photodetector devices 320a-320d can be positioned on the second side of the support substrate 334 corresponding to and/or mirroring the line of light sources 310a-310d positioned on the first side of the support substrate 334.

As described above, the apparatus 300 can be used to determine the thickness of graphene oxide coatings disposed on a support substrate 334. For example, in some instances, the light source 310 can be coupled to a control unit (not shown) to activate and/or control the operation of the light source devices 310a-310d. The light source devices 310a-310d can be activated simultaneously to illuminate a number of points and/or regions corresponding to the number of photodetector devices positioned along the line perpendicular to the direction of web travel. The incident light produced and/or emitted by the light source devices 310a-310d can penetrate and/or travel through the support substrate 334 and the graphene oxide coating and exit as transmitted light on the surface of the graphene oxide coating. The photodetector devices 320a-320d can be configured to detect and/or measure a plurality of intensities of transmitted light on the surface of the graphene oxide coating. For example, the photodetector 320 can be coupled to the control unit (not shown) to activate and/or control the operation of the photodetector devices 320a-320d. In some instances, the photodetector devices 320a-320d can be activated simultaneously prior to, or during activation of the light source devices 310a-310d. In that way, the photodetector devices 320a-320d can detect and/or measure the transmitted light emitted by the photodetector devices 320a-320d. The transmitted light detected and/or measured by the photodetector devices 320a-320d can be recorded by a control unit (not shown) and can be used to determine the relative and/or absolute thickness of the graphene oxide coating.

The intensity of the light transmitted on the surface of the graphene oxide coating detected by each one of the photodetector devices 320a-320d can be compared with a reference level in order to determine the thickness of the graphene oxide coating. Without reiterating, the methods for determining the absolute or relative thickness of the graphene oxide coatings using the apparatus 300 are the same or substantially the same as those described above in relation to the apparatus 100. While various embodiments have been described above, it should be understood that they have been presented by way of example only, and not limitation. While the embodiments have been particularly shown and described, it will be understood that various changes in form and details may be made. Where schematics and/or embodiments described above indicate certain components arranged in certain orientations or positions, the arrangement of components may be modified. Although various embodiments have been described as having particular features and/or combinations of components, other embodiments are possible having a combination of any features and/or components from any of embodiments as discussed above. For example, as described above, the apparatus 300 can be a combination of certain features and/or aspects of the apparatus 100 and the apparatus 200.

As used in this specification and in the claims, the singular forms “a,” “an,” and “the” include plural referents unless the context clearly dictates otherwise. Thus, for example, the term “a member” is intended to mean a single member or a combination of members, “a material” is intended to mean one or more materials or a combination thereof, etc.

As used herein, the terms “about,” “approximately,” and/or “substantially” when used in connection with a stated value(s) and/or a geometric structure(s) or relationship(s) is intended to convey that the value or characteristic so defined is nominally the value stated and/or characteristic described. In some instances, the terms “about,” “approximately,” and/or “substantially” can generally mean and/or can generally contemplate a value or characteristic stated within a desirable tolerance (e.g., plus or minus 10% of the value or characteristic stated). For example, a value of about 0.01 would include 0.009 and 0.011, a value of about 0.5 would include 0.45 and 0.55, a value of about 10 would include 9 to 11, and a value of about 1000 would include 900 to 1100. While a value, structure, and/or relationship stated may be desirable, it should be understood that some variance may occur as a result of, for example, manufacturing tolerances or other practical considerations (such as, for example, the pressure or force applied through a portion of a device, conduit, lumen, etc.). Accordingly, the terms “about,” “approximately,” and/or “substantially” can be used herein to account for such tolerances and/or considerations.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

As used herein, the phrase “and/or,” should be understood to mean “either or both” of the elements so conjoined (e.g., elements that are conjunctively present in some cases and disjunctively present in other cases). Multiple elements listed with “and/or” should be construed in the same fashion (e.g., “one or more” of the elements so conjoined). Other elements may optionally be present other than the elements specifically identified by the “and/or” clause, whether related or unrelated to those elements specifically identified. Thus, as a non-limiting example, a reference to “A and/or B”, when used in conjunction with open-ended language such as “including,” “comprising,” etc., can refer, in one implementation, to A only (optionally including elements other than B); in another implementation, to B only (optionally including elements other than A); and in yet another implementation, to both A and B (optionally including other elements).

As used herein, the term “or” should be understood to have the same meaning as “and/or” as defined above. For example, when separating items in a list, “or” or “and/or” shall be interpreted as being inclusive (e.g., the inclusion of at least one, but also including more than one) of a number or list of elements, and, optionally, additional unlisted items.

1. An apparatus configured to measure a thickness of a graphene oxide coating disposed on a support substrate, the apparatus comprising:
a light source configured to be positioned on a first side of the support substrate and illuminate the support substrate with incident light, the incident light traveling through the support substrate and the graphene oxide coating to exit as transmitted light; and
a photodetector configured to be positioned on a second side of the support substrate and measure an intensity of the transmitted light.

2. The apparatus of claim 1, further comprising a conveyor system configured to move the support substrate in a direction perpendicular to the direction of the incident light, thereby permitting the apparatus to measure the thickness continuously.

3. The apparatus of claim 1, further comprising a power source coupled to the light source and configured to provide power to the light source.

4. The apparatus of claim 1, wherein the light source has a wavelength in the range of about 200 nm to about 600 nm.

5. (canceled).

6. The apparatus of claims 1, wherein the light source is a light-emitting diode (LED), a laser, a mercury lamp, or a metal halide lamp.

7. The apparatus of claim 1, wherein the light source includes comprising a plurality of light sources.

8. The apparatus of claim 7, wherein the plurality of light sources is arranged in an array.

9. (canceled).

10. The apparatus of any one of claims 1-9, wherein the photodetector is a charge-coupled device (CCD), a photomultiplier, or a photodiode.

11. The apparatus of claim 1, wherein the photodetector includes a plurality of the photodetectors.

12. The apparatus of claim 11, wherein the plurality of the photodetectors is arranged in an array.

13. (canceled).

14. The apparatus of claim 1, further comprising a processor configured to receive data from the photodetector indicative of the intensity of the transmitted light.

15. The apparatus of claim 14, wherein the processor is further configured to analyze the received data to determine a relative or absolute thickness of the graphene oxide coating.

16. The apparatus of claim 15, wherein the processor comprises a non-transitory processor-readable medium storing code representing instructions to be executed by the processor, the code to cause the processor to:
compare the intensity of the transmitted light with a calibration curve; and
calculate the absolute thickness based on the calibration curve.

17. The apparatus of claim 1, further comprising a heat sink coupled to the light source and configured to prevent the light source from overheating.

18. A method of measuring a thickness of a graphene oxide coating disposed on a support substrate, the method comprising:
illuminating incident light from a light source onto the support substrate, the incident light traveling through the support substrate and the graphene oxide coating to exit as transmitted light;
measuring an intensity of the transmitted light with a photodetector;
comparing the intensity of the transmitted light with a reference level; and
determining a relative or an absolute thickness of the graphene oxide coating based on the comparison.

19. The method of claim 18, wherein the light source has a wavelength in the range of about 200 nm to about 600 nm.

20. (canceled).

21. The method of claim 18, wherein the light source is a light-emitting diode (LED), a laser, a mercury lamp, or a metal halide lamp.

22. The method of claim 18, wherein the photodetector is a charge-coupled device (CCD), a photomultiplier, or a photodiode.

23. The method of claim 18, wherein the reference level is an intensity of transmitted light measured for a control graphene oxide coating having a known thickness, the control graphene oxide coating being disposed on the support substrate.

24. The method of claim 18, further comprising:
comparing the relative thickness with a calibration curve; and
converting the relative thickness to the absolute thickness based on the calibration curve.

25. The method of claim 19, wherein the support substrate comprises polypropylene, polystyrene, polyethylene, polyethylene oxide, polyethersulfone, polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, polycarbonate, nylon, Kevlar or other aramid, polyether ether ketone, or a combination thereof.

26. The method of claim 18, wherein:
the support substrate moves in a direction perpendicular to the direction of the incident light; and
the method determines the relative or the absolute thickness of the graphene oxide coating continuously.

27. A method, comprising:
moving a support substrate disposed on a conveyor system in a first direction;
illuminating, with incident light from a light source, a graphene oxide coating disposed on the support substrate, the incident light traveling in a second direction perpendicular to the first direction, the incident light traveling through the support substrate and the graphene oxide coating to exit as transmitted light;
measuring an intensity of the transmitted light with a photodetector;
receiving, via a processor, data from the photodetector indicative of the measured intensity of the transmitted light;
comparing, via the processor, the intensity of the transmitted light with a reference level;
determining continuously, via the processor, a relative or an absolute thickness of the support substrate based on the comparison with the reference level.

28. The method of claim 27, wherein the light source has a wavelength in the range of about 200 nm to about 600 nm.

29. The method of claim 27, wherein the reference level is an intensity of transmitted light measured for a control graphene oxide coating having a known thickness, the control graphene oxide coating being disposed on the support substrate.

30. The method of claim 27, wherein the photodetector is a charge-coupled device (CCD), a photomultiplier, or a photodiode.
